(19) United States
(12) Patent Application Publication
(10) Pub. No.: US 2017/0108944 A1
(43) Pub. Date: Apr. 20, 2017

(54) LIGHT CONDUCTOR DEVICE

(71) Applicants: DENSO International America, Inc., Southfield, MI (US); DENSO CORPORATION, Kariya-city (JP)

(72) Inventors: Cary Horvath, Dearborn, MI (US); Marc Arceo, Livonia, MI (US); Gareth Webb, Farmington, MI (US)

(21) Appl. No.: 14/882,556

(22) Filed: Oct. 14, 2015

(51) Int. Cl. G06F 3/0362; G06F 3/038; G02B 27/02

(52) U.S. Cl. CPC G06F 3/0362; G02B 27/022; G06F 3/038

(57) ABSTRACT

A light conductor is non-opaque and has a bottom surface and a top surface, which are distant from each other in a height direction. A display device has a screen configured to create an indication. The bottom surface of the light conductor is faced to the display device and to elevate the indication to show the indication on the top surface of the light conductor.

### TECHNICAL FIELD

The present disclosure relates to a light conductor device.

### BACKGROUND

For example, a vehicle is equipped with various devices such as an operational device and a display device to enable a user to manipulate an operational state and/or to retrieve information. An operational device and/or a display device may have an additional or different indication form.

### SUMMARY

According to an aspect of the preset disclosure, a light conductor may be non-opaque and may have a bottom surface and a top surface, which are distant from each other. A display device may have a screen configured to show an indication on the screen. The bottom surface of light conductor may be faced to the screen. The light conductor may be configured to elevate the indication on the screen through the light conductor to show the indication on the top surface.

### BRIEF DESCRIPTION OF THE DRAWINGS

The above and other objects, features and advantages of the present invention will become more apparent from the following detailed description made with reference to the accompanying drawings. In the drawings:

FIG. 1 is an exploded view showing components of a light conductor device of a first embodiment;

FIG. 2 is an exploded view showing the components;

FIG. 3 is a perspective view showing the light conductor device;

FIGS. 4 to 11 are top views each showing an example of the light conductor device;

FIG. 12 is a perspective view showing a light conductor device of a second embodiment;

FIG. 13 is a perspective view showing a light conductor device of a third embodiment; and

FIG. 14 is a partial sectional view showing the light conductor device of the third embodiment.

### DETAILED DESCRIPTION

### First Embodiment

As follows, a first embodiment of the present disclosure will be described with reference to drawings. In the description, a height direction is along an arrow represented by “HEIGHT” in drawing(s). A radial direction is along an arrow represented by “RADIAL” in drawing(s). A circumferential direction is along an arrow represented by “CIRCUMFERENTIAL” in drawing(s).

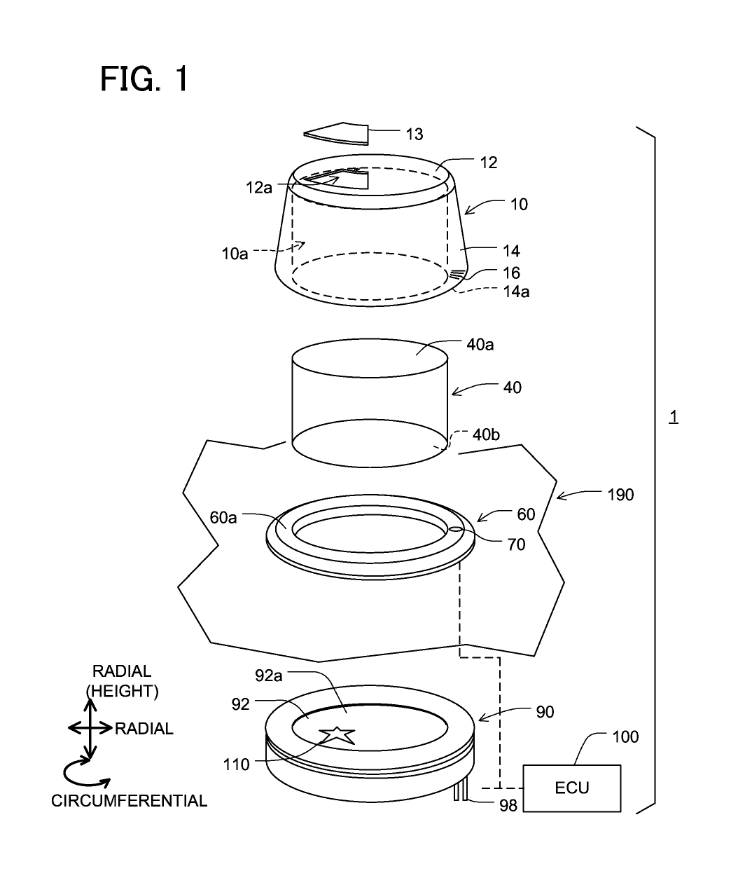

As shown in FIG. 1, a light conductor device 1 may include a knob 10, a light conductor 40, a bezel 60, and a display device 90.

The knob 10 may include a top wall 12 and a sidewall 14, which may be integrally molded of an opaque plastic material by injection molding. The opaque plastic material may be, for example, ABS resin. The top wall 12 may be in a circular plate shape. The sidewall 14 may be in a tubular shape extending in the circumferential direction. The knob 12 may expand to the bottom side to form a chamfered conical shape.

The top wall 12 and the sidewall 14 may be integrated into a hollow one piece to form an internal space 10a. The knob 10 may have a window 12a in the top wall 12. The window 12a may be a through hole extending through the top wall 12. The window 12a may be in a sector shape. The window 12a may open in the circumferential direction in an angular range and in the radial direction in a radial length. The window 12a may be equipped with a shield 13, which may be formed of a non-opaque material such as acrylic resin (PMMA) or polycarbonate resin. The window 12a may enable to view the internal space 10a of the knob 10 from exterior of the knob 10. In addition, the top wall 12 excluding the window 12a may conceal the internal space 10a. In another example, the window 12a may be in an annular shape or in a circular shape to open entirely in the circumferential direction. In another example, the knob 10 may be integrally formed of a non-opaque material, and the knob 10, excluding the window 12a, may be painted to be opaque to leave the window 12a as non-opaque.

The light conductor 40 may be integrally molded of a non-opaque light-conductive material as a monolithic component. The light conductor 40 may be transparent. The non-opaque light-conductive material may be formed of acrylic resin (PMMA) or polycarbonate resin by, for example, injection molding or extrusion. The non-opaque light-conductive material may be formed of another material capable of conducting an image therethrough. The light conductor 40 may be in a columnar shape having a circular cross section. The light conductor 40 may have a top surface 40a and a bottom surface 40b, which may be distant from each other in the height direction. In the present example, the top surface 40a and the bottom surface 40b may be in parallel with each other.

The bezel 60 may be integrally molded of an opaque plastic material such as ABS resin. The bezel 60 may be in an annular shape extending in the circumferential direction and having a width in the radial direction. The bezel 60 may have a top surface 60a, which may be a flat surface in a ring shape. The top surface 60a of the bezel 60 may be equipped with a sensor 70. The sensor 70 may be an optical detector embedded in the top surface 40a and directed upward in the height direction.

The display device 90 may have a screen 92 configured to create an indication (symbol). The display device 90 may be, for example, an LCD display or an organic EL display having, for example, a full-color dot-matrix configuration having multiple pixels, which may be selectively activated. More specifically, the display device 90 may be an active matrix display such as a TFT LCD display and may have a lighting device to emit light to the screen 92. The display device 90 may be an organic EL display having a self-luminous configuration without an additional lighting device. The display device 90 may be configured to indicate, for example, a full-color moving picture on the screen 92. In the example of FIG. 1, the display device 90 may indicate a symbol 110 on the screen 92. The symbol 110 may be in various forms such as a graphic pattern, a letter, and/or a gradation image.

The display device 90 may accommodate a driver circuit for controlling activation of the pixels, the lighting device, and an I/O device 98. The I/O device 98 may be connectable with an external circuit such as an ECU 100 (electronic control device) of the vehicle to receive an electric power and to exchange graphic information related to the indication with the ECU 100. The display device 90 may further include a microcomputer configured with a CPU and a storage device for processing the graphic information. In the present example, the screen 92 may be in a circular shape, and the display device 90 may be in a circular shape correspondingly. The display device 90 may be mounted on a printed circuit board (PCB).

The bezel 60 may be equipped to a base plate 190, which may be a part of a control panel and/or a head unit of the vehicle. The base plate 190 may be opaque and may be formed of resin such as ABS resin. The display device 90 may be equipped to a bottom side of the bezel 60, such that the base plate 190 is interposed between the display device 90 and the bezel 60. Thus, the bezel 60 and the display device 90 may be affixed to and supported by the base plate 190.

The light conductor 40 may be inserted into a center of the bezel 60. Specifically, a bottom portion of the light conductor 40 may be press-fitted to an inner periphery of the center of the bezel 60. Thus, the bezel 60 may receive the light conductor 40. The light conductor 40 may be affixed to a screen surface 92a of the screen 92. Specifically, the bottom surface 40b of the light conductor 40 may be adhered to the screen surface 92a with adhesion.

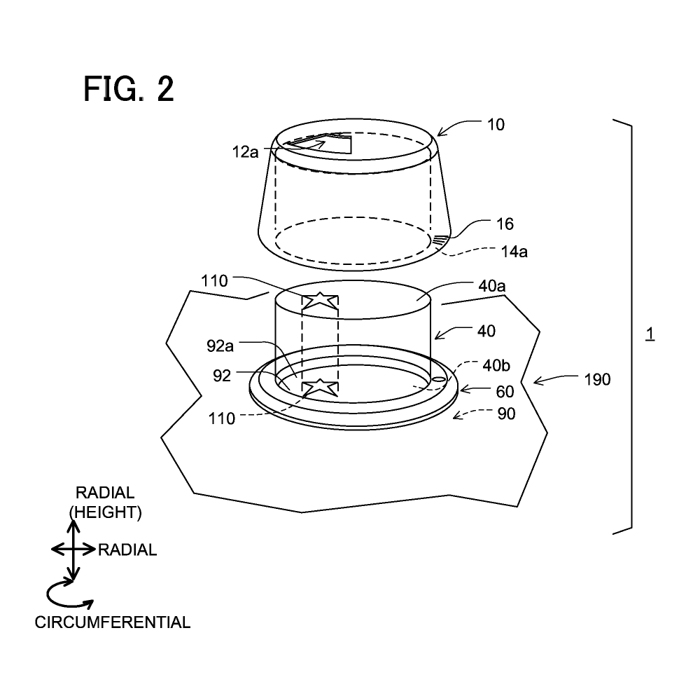

In FIG. 2, the bottom surface 40b of the light conductor 40 may be faced to the screen 92 of the display device 90 and may be configured elevate the symbol 110 (indication) created on the screen surface 92a of the screen 92. Specifically, the light conductor 40 may optically conduct the symbol 110 linearly therethrough from the bottom surface 40b to the top surface 40a. Thus, the light conductor 40 may project the symbol 110 on the top surface 40a.

Subsequently, the knob 10 may be mounted on the light conductor 40 and the bezel 60. Thus, the knob 10 being a hollow member may accommodate a top portion of the light conductor 40, such that the window 12a of the knob 10 is faced to the top surface 40a of the light conductor 40. In addition, the top surface 60a of the bezel 60 may be in contact with a bottom surface of the knob 10 to support the knob 10.

The knob 10 may be rotational relative to the light conductor 40 and the bezel 60. Specifically, an inner circumferential periphery of the sidewall 14 of the knob 10 may be fitted to an outer circumferential periphery of the light conductor 40 via lubricant such as grease. The knob 10 may be coupled with the light conductor 40 and/or the bezel 60 via a bearing (not shown).

The sidewall 14 of the knob 10 may have a bottom surface 14a having slits 16. The slits 16 may be arranged in the bottom surface 14a entirely in the circumferential direction. The slits 16 of the knob 10 and the sensor 70 of the bezel 60 may be faced to each other to form a rotary encoder. Specifically, the sensor 70 may be configured to count the slits 16 in an optical manner while the knob 10 is rotated thereby to detect the rotary position of the knob 10. The sensor 70 and the slits 16 may be one example of a rotary encoder. The rotary encoder may employ various configurations such as a magnetic coupling using a hall element.

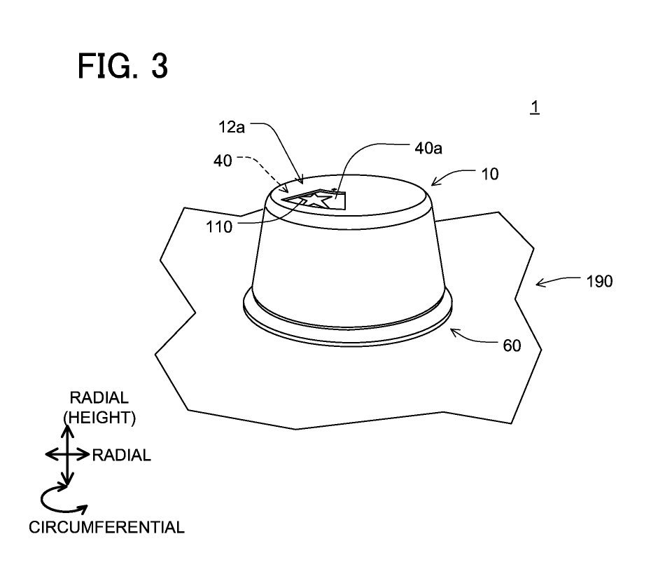

In FIG. 3, the knob 10 may be mounted rotationally on the light conductor 40 and the bezel 60. The window 12a may show the symbol 110 indicated on the top surface 40a of the light conductor 40. The light conductor device 1 including the knob 10 may be employed for various operational devices. The knob 10 may be utilized for, for example, an operational console of an air conditioning device. The knob 10 may be used to set a set temperature of a cabin of the vehicle.

In FIG. 1, the ECU 100 may control the display device 90 to modify the indication of the display device 90 to show an indication such as the symbol 110 in the window 12a. The ECU 100 may cause the display device 90 to modify the symbol 110 shown in the window 12a according to the rotary position of the knob 10.

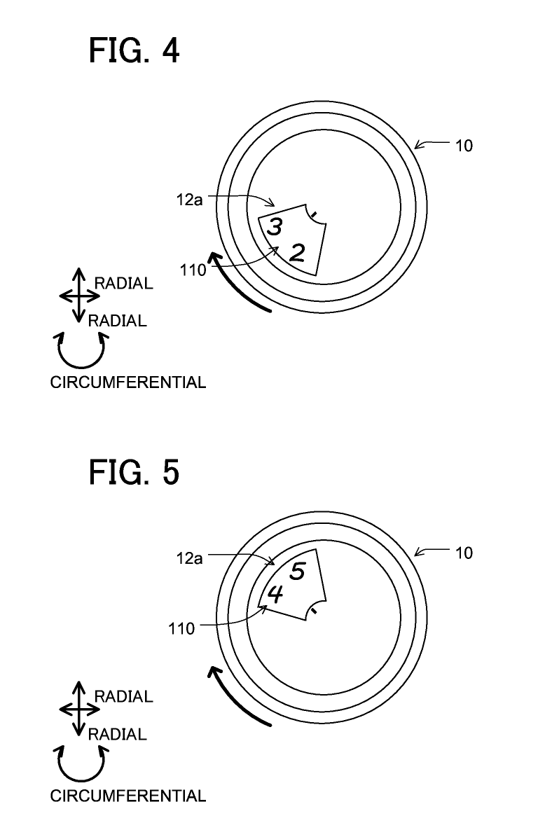

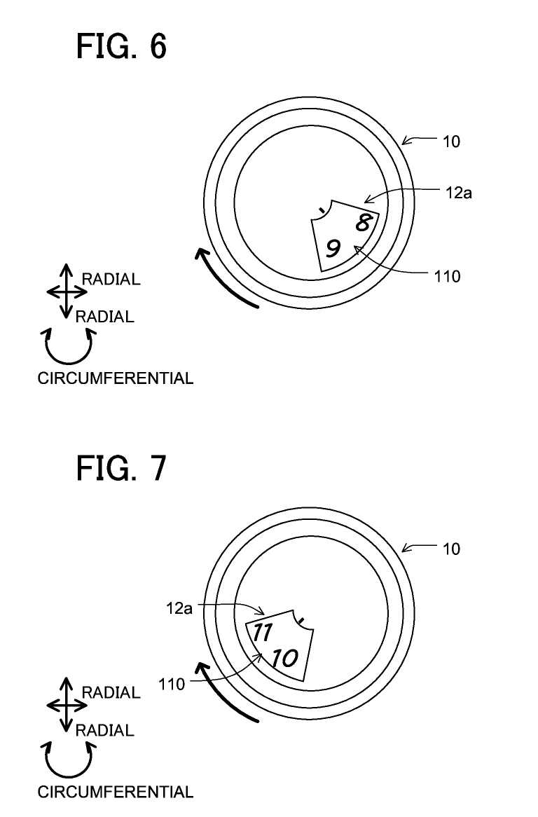

FIGS. 4 to 7 show an example of the light conductor device 1. In the example, the ECU 100 may cause the display device 90 to indicate numeral symbols 110 according to the rotary position of the knob 10. In FIG. 4, the window 12a may be located at the lower left position (first rotary position) in the drawing. In FIG. 5, the knob 10 may be rotated by 90 degrees clockwise from the position of FIG. 4, and the window 12a may be located at the upper left position in the drawing. In FIG. 6, the knob 10 may be further rotated by 180 degrees clockwise from the position of FIG. 5, and the window 12a may be located at the lower right position in the drawing. In FIG. 7, the knob 10 may be further rotated by 90 degrees clockwise from the position of FIG. 6, and the window 12a may be located at the lower left position in the drawing. That is, in FIG. 7, the rotary position of the knob 10 may be returned to the first rotary position in FIG. 4. In FIGS. 4 to 7, the numeral symbols 110 shown through the window 12a increases sequentially from 2 to 11. In FIG. 4, the ECU 100 may cause the display device 90 to indicate 2 and 3 (example of a first numeral) when the knob 10 is at the first rotary position. In FIG. 7, the ECU 100 may cause the display device 90 to indicate 10 and 11 (example of a second numeral) when the knob 10 is rotated and returned to the first rotary position. In this way, the knob 10 may indicate the numerals to increase or decrease sequentially when the knob 10 is rotated beyond 360 degrees.

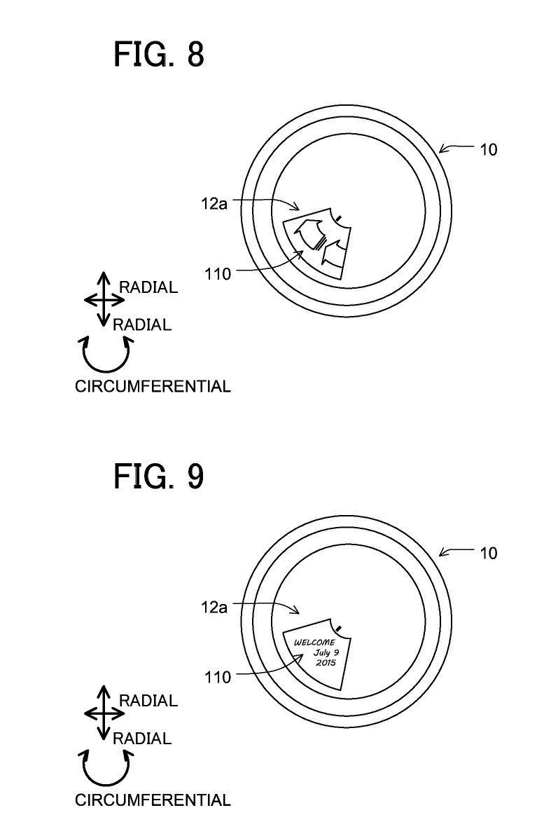

In FIG. 8, the ECU 100 may cause the display device 90 to indicate a symbol 110. In the example, the symbol 110 may be arrows 110, which may instruct a user of a direction in which the knob 10 is to be rotated. In this way, the ECU 100 may instruct a user of a desirable operation.

In FIG. 9, the symbol 110 may be letters 110. In the example, the letters 110 may represent a welcome message. The letters 110 may indicate various information such as year, date, time, temperature, speed, fuel consumption, and/or the like.

In the examples, the symbol 110 may slowly follows the window 12a when the knob 10 is rotated. Specifically, the symbol 110 may stay at a position for a short time immediately after the knob 10 is rotated to revolve the window 12a, and subsequently, the symbol 110 may start to move to stay in the window 12a.

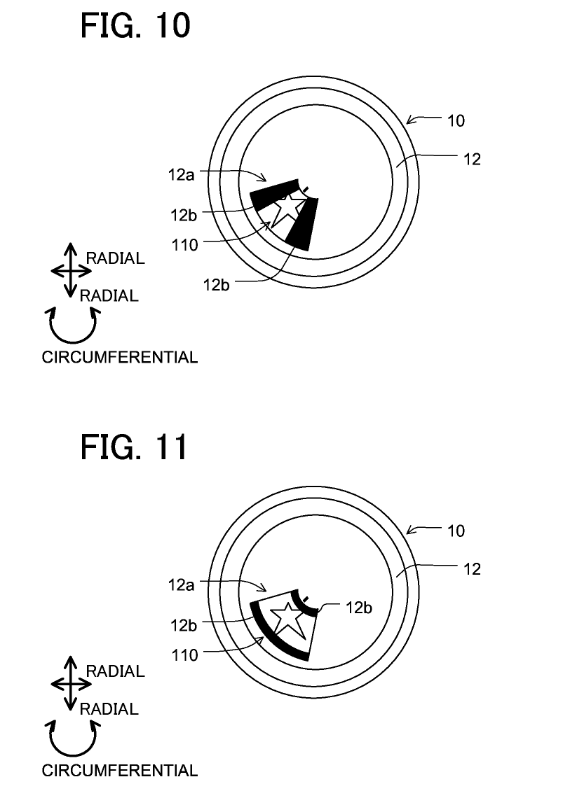

In FIG. 10, the ECU 100 may cause the display device 90 to narrow the window 12a in the circumferential direction. Specifically, the display device 90 may indicate shutters 12b on circumferential ends in the window 12a. The shutter 12b may be in a similar color to the color of the top wall 12 of the knob 10. Thus, the shutters 12b may be viewed as a part of the top wall 12. The shutters 12b may function as an extension of the peripheries of the window 12a to close the window 12a partially in the circumferential direction. The shutter 12b may be on one side in the circumferential direction. In FIG. 11, the ECU 100 may cause the display device 90 to narrow the window 12a in the radial direction. Similarly to FIG. 10, the display device 90 may indicate shutters 12b on radial ends in the window 12a. The shutters 12b may function as an extension of the peripheries of the window 12a to close the window 12a partially in the radial direction. The shutter 12b may be on one side in the radial direction.

### Second Embodiment

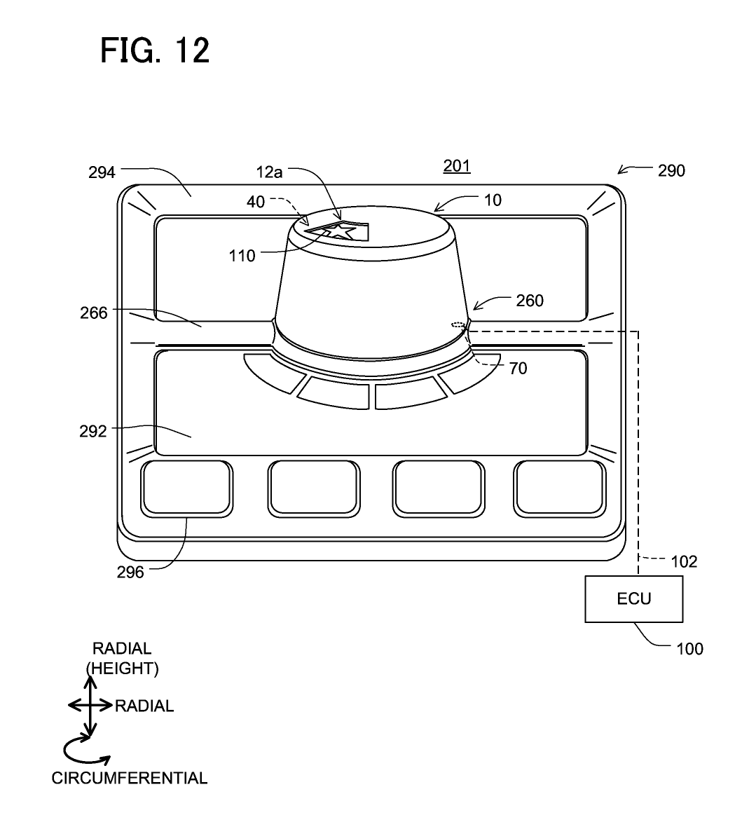

As in the example of FIG. 12, a light conductor device 201 may be mounted on a display device 290. In the example, the display device 290 may have a screen 292 greater than the screen 92 of the first embodiment. The display device 290 may be, for example, a vehicular display device for an infotainment system. The display device 290 may indicate various information such as a navigation map, audiovisual contents, operation icons, and/or the like. The display device 290 may have a frame 294 surrounding the screen 292. The frame 294 may be equipped with mechanical switches 296.

The frame 294 may have a bracket 266. The bracket 266 may support a bezel 260 of the light conductor device 201 at both sides. The bezel 60 may be affixed to an indication surface of the screen 292 and may be supported by the frame 294 via the bracket 266. The frame 294, the bracket 266, and the bezel 60 may be integrally formed of resin such as ABS resin.

In the example, the bracket 266 may include an electric wire 102 connecting the sensor 70 of the bezel 60 with the ECU 100. The electric wire 102 may conduct a detection signal from the sensor 70 to the ECU 100.

The display device 290 may indicate the symbol 110 at the position corresponding to the window 12a of the knob 10 thereby to enable to show the symbol 110 in the window 12a.

### Third Embodiment

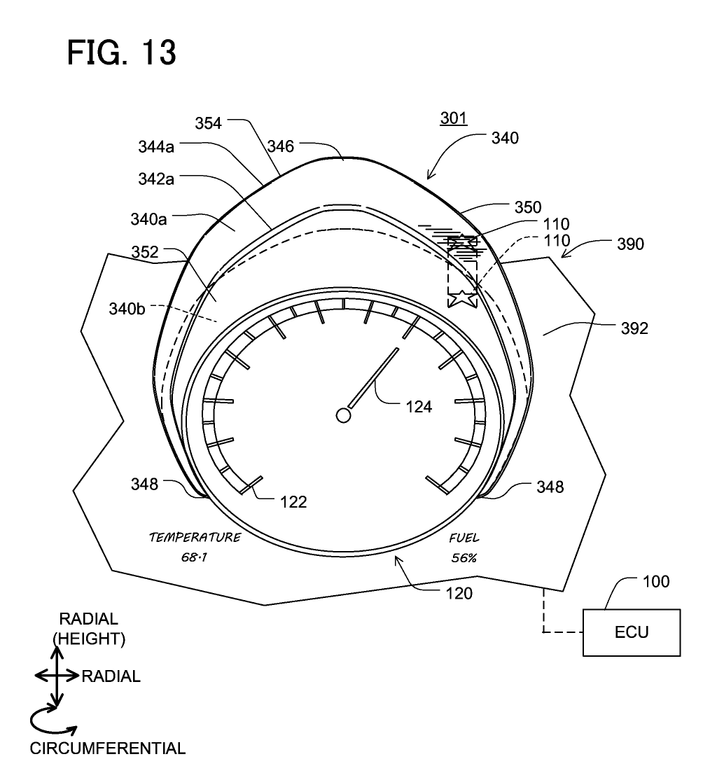

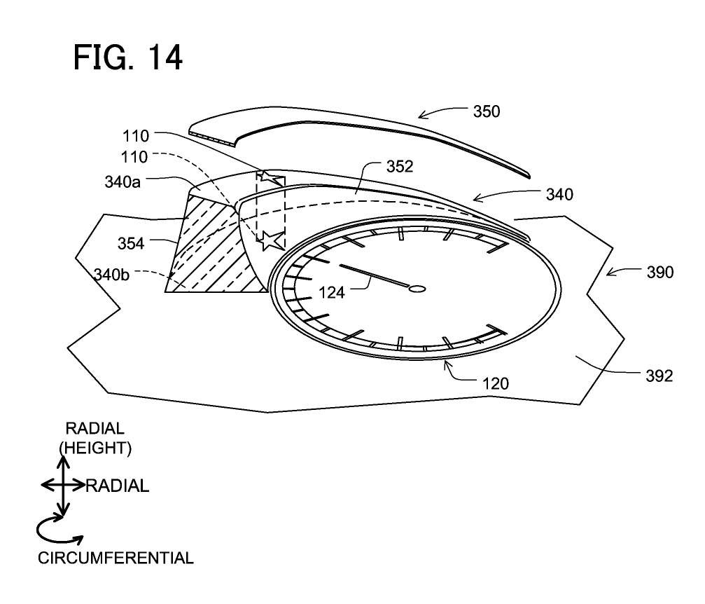

As in the example of FIGS. 13 and 14, a light conductor device 301 may include a light conductor 340. The light conductor 340 may be in an arch shape (C-shape) having a width. The light conductor 340 may be mounted on a display device 390. In the example, the display device 390 may be a part of a meter cluster of a vehicle. The display device 390 may have a large flat screen 392 such as a TFT LCD display and/or an organic EL display. The display device 390 may indicate a meter 120 in a circular shape. The meter 120 may include a scale 122 and a pointer 124 for indicating information such as a vehicular speed and/or an engine revolution. The display device 390 may further indicate various information such as a temperature outside the vehicle and/or remaining fuel.

The light conductor 340 may be combined with the meter 120 to surround the meter 120. The light conductor 340 may have a top surface 340a and a bottom surface 340b, which may be in arch shapes. The top surface 340a may be defined with an inner arc 342a and an outer arc 344a. The outer arc 344a may be located on the radially outside of the inner arc 342a and may be greater than the inner arc 342a. Ends 348 of the outer arc 344a and ends 348 of the inner arc 342a may be at the same positions, respectively. Thus, the outer arc 344a and the inner arc 342a may form the top surface 340a in a bold C-shape. The top surface 340a may be in a crescent shape widened at an intermediate position 346 and thinned at the ends 348. The light conductor 340 may have an inner surface 352 and an outer surface 354, which are in C-shapes. The inner surface 352 and an outer surface 354 may be opaque. The top surface 340a and the bottom surface 340b may be located between the inner surface 352 and an outer surface 354.

In the example, in FIG. 14, the top surface 340a of the light conductor 340 may be at an angle relative to the bottom surface 340b. The top surface 340a may be equipped with an optical filter 350. The optical filter 350 may be non-opaque and may conduct a symbol 110 shown on the top surface 340a of the light conductor 340 therethough to a top surface of the optical filter 350. The optical filter 350 may have a structure to add an optical effect on the symbol 110. For example, the optical filter 350 may have a coarse surface to blur the symbol 110 shown on the top surface of the optical filter 350.

The ECU 100 may cause the display device 390 to indicate the symbol 110 on the screen 392. Similarly to the above-described embodiments, the symbol 110 may be in various forms such as a graphic pattern, a letter, a gradation image. The ECU 100 may create the symbol 110 according to an operating condition of the vehicle such as a speed, engine revolution, traffic condition, and/or the like. The display device 390 may indicate the symbol 110 at a position directed by the pointer 124. The display device 390 may indicate a graphic effect such as blur gradation corresponding to the position directed by the pointer 124.

The inner surface and the outer surface may conceal the bottom surface 340b and may enable a user to view the symbol 110 shown on the top surface 340a.

### Other Embodiment

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it may be to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A light conductor device comprising:
a light conductor being non-opaque and having a bottom surface and a top surface, which are distant from each other; and
a display device having a screen configured to show an indication on the screen, wherein
the bottom surface of the light conductor is faced to the screen, and
the light conductor is configured to elevate the indication on the screen therethrough to show the indication on the top surface.

2. The light conductor device of claim 1, further comprising:
a knob being hollow and accommodating the light conductor, wherein
the knob has a top wall having a window, and
the window is faced to the top surface of the light conductor.

3. The light conductor device of claim 2, wherein
the top wall of the knob is in a circular shape, and
the window opens in a circumferential direction in an angular range.

4. The light conductor device of claim 1, wherein
the top surface and the bottom surface are in parallel with each other.

5. The light conductor device of claim 2, further comprising:
a bezel configured to receive the light conductor and to support the knob.

6. The light conductor device of claim 5, wherein
the bezel and the display device are affixed to a base plate and supported by the base plate.

7. The light conductor device of claim 2, further comprising:
a controller configured to control the display device, wherein
the controller is configured to modify the indication according to a rotary position of the knob.

8. The light conductor device of claim 7, wherein
the controller is configured to cause the display device to indicate a numeral symbol according to the rotary position of the knob.

9. The light conductor device of claim 8, wherein
the controller is configured to cause the display device to indicate a first numeral when the knob is at a first rotary position and to indicate a second numeral, which is different from the first numeral, when the knob is rotated to the first rotary position again.

10. The light conductor device of claim 8, wherein
the controller is configured to cause the display device to indicate a symbol, which slowly follows the window when the knob is rotated.

11. The light conductor device of claim 8, wherein
the controller is configured to cause the display device to indicate a symbol, which instructs a user of a direction in which the knob is to be rotated.

12. The light conductor device of claim 8, wherein
the controller is configured to cause the display device to narrow the window in at least one of a circumferential direction and a radial direction.

13. The light conductor device of claim 5, further comprising:
a sensor equipped to the bezel and configured to detect a rotary position of the knob; and
a bracket supporting the bezel, wherein
the bracket includes an electric wire to conduct a detection signal from the sensor.

14. The light conductor device of claim 1, further comprising:
the light conductor is in an arch shape,
the display device is configured to indicate a meter in a circular shape, and
the light conductor surrounds the meter.

15. The light conductor device of claim 14, wherein
the top surface is at an angle relative to the bottom surface.
